(19) United States
(12) Patent Application Publication
(10) Pub. No.: US 2014/0207948 A1
(43) Pub. Date: Jul. 24, 2014

(54) NETWORK INTERFACE ON A CHIP WITH AN ADAPTIVE SYSTEM TO TRIGGER DATA FORWARDING

(71) Applicant: COMMISSARIAT A L'ENERGIE ATOMIQUE ET AUX ENE ALT, Paris (FR)

(72) Inventors: Romain LEMAIRE, Seyssinet-Pariset (FR); Fabien Clermidy, Saint-Egreve (FR)

(73) Assignee: COMMISSARIAT A L'ENERGIE ATOMIQUE ET AUX ENE ALT, Paris (FR)

(21) Appl. No.: 14/161,346

(22) Filed: Jan. 22, 2014

(30) Foreign Application Priority Data
Jan. 21, 2013 (FR) 13 50520

(51) Int. Cl. H04L 12/911; H04L 12/26

(52) U.S. Cl. CPC H04L 47/78; H04L 43/08
USPC 709/224; 709/226

(57) ABSTRACT

A network interface for a network on chip resource having a communication controller including recording means, and designed to transmit data to another network interface when a quantity of data present in the recording means reaches a predetermined threshold, and where the communication controller also includes means to force a transmission of data present in the said recording means when the quantity of this data is below the predetermined threshold.

### TECHNICAL FIELD

The present invention relates to the field of Systems on Chips (SoC) implementing a Network on Chip (NoC), and more specifically that of network interfaces in a network on chip.

It offers an improved network interface, enabling latency to be reduced in a network on chip.

### PRIOR ART

To meet the requirements of applications such as high-resolution video decoding, or high-speed wireless data transmission, it is known to implement network on chip architectures known as “heterogeneous” architectures, i.e. architectures which consist of processing elements also called resources of different natures, and which may take the form of processor(s), hardware accelerator(s), reconfigurable unit(s) or memory(ies).

A NoC architecture includes multiple resources 1 able to communicate between one another, and to exchange data with one another. Each resource 1 in the network structure includes a portion or means which are called the functional core or processing unit 12, which is dedicated in particular to data processing and/or computation, and also means or another portion which is called the network interface 13, and which enables resource 1 to communicate with the network (FIG. 1).

Network interfaces 13 enable the implementation details of communications in the processing units to be disregarded. The role of a network interface is to manage locally the incoming and outgoing communications of the processing unit such that, as experienced by the latter, everything occurs as though the connections with the other processing units were of the point-to-point type. Network interfaces enable processing units of different natures to communicate with one another. A network on chip thus uses an interface layer enabling the communications between the different elements or resources in the network to be managed.

Documents EP 1°641°197 A1 and EP 1°835°411 A1 disclose network on chip architectures according to the prior art, in which data exchange protocols enable messages to be transferred in the form of data packets.

A packet is formed of a number of data elements associated with protocol data elements, such as data concerning the origin of the packet and/or the destination of the packet.

In particular there are 2 types of data:
data for processing sent by a resource which produces data for processing, and data received by a data-consuming resource, which is intended to process this data;
credit data sent by a resource which consumes data for processing, to enable a resource which produces data for processing to be informed that the consuming resource is ready to receive data for processing.

A network interface 13 generally includes an input communication controller module.

Depending on the manner in which it is configured this input communication controller module notably enables the resource to transmit credits to other resources in the network.

When it is intended to receive data for processing, or to transmit data originating from a second resource, a first resource first sends credits to the second resource to inform it that it, the first resource, is authorised to send the said data for processing or for transmission. The number of credits sent by the first resource may enable the second resource to be informed of the quantity of data which this second resource is authorised to send to the first resource. This number of credits depends on the free space which is available to the first resource as input, and also the quantity of data which the first resource is intended to receive from the second resource. When it is authorised to transmit, due to the receipt of credits, the second resource is able to transmit as much data as permitted by the number of credits sent by the first resource.

Transmission of credits from the first resource to the second resource thus enables a path to be opened for data from the second resource and intended to be sent to the first resource. This credit transmission mechanism enables it to be guaranteed that a data element transmitted by the second resource can be received by the first resource.

A network interface also includes an output communication controller module. This output communication controller module is associated with one or more output storage means through which the resource's outgoing data will transit. These storage means may take the form of one or more FIFO units, or one or more memory(ies), the fill rate and free addresses of which the outgoing data controller module will be able to know. The output communication controller module may be designed notably, depending on how it is configured, to create data packets to be transmitted to one or more other receiving resources.

To reduce the additional bandwidth cost relating to the protocol data, it is generally sought to reduce the number of packets transmitted by a network interface of one resource to another network interface of another resource in the network, and to increase the size of the packets.

By this means several data elements for processing, or credits, are grouped together in the same packet. However, its effect may be to introduce substantial latency.

If a network interface is expecting a large quantity of data to be available in order before sending a new packet, the transfer of the initially produced data, and processing of it, may be substantially delayed.

It is thus generally sought to find a compromise between undertaking a data/credits transmission in a per-unit fashion, in order to obtain a small degree of latency, but with the disadvantage that it creates substantial network traffic, and grouping credits/data into packets, which reduces the traffic but increases latency and processing times.

This compromise is generally obtained by considering the number of routing nodes present between a data-emitting resource and a data-receiving resource, but also the size of the FIFO-type memories present in the network interface communication controllers, in order to delay the data streams between the network and the processing units.

Communication parameters such as the size of the data packets, and the threshold for transmission of credits, may be defined in terms of the NoC and SoC in question.

These parameters may be supplied to the communication controllers by means of configuration or programs also for example containing routing parameters. These parameters are generally established in a fixed fashion for the entire duration over which a communication link between network interfaces is used.

The problem of implementing an improved network interface in a network on chip which does not have the above disadvantages is posed.

### DESCRIPTION OF THE INVENTION

The present invention relates firstly to a network interface for a system on chip resource able to interface a data processing unit of the said resource with a system on chip network, where the network interface has an input communication controller including:
means for transmitting credits,
means for receiving data for processing,

where the interface also has an output communication controller including:
means for receiving credit data,
means for transmitting data for processing, where at least one given communication controller of the said input and output communication controllers of the said interface also has storage means and is adapted to transmit data to another network interface when a quantity of data present in the storage means reaches a predetermined threshold, and where the communication controller also includes means to force data or credits present in the said storage means to be transmitted when the quantity of this data is below the said predetermined threshold.

Thus, according to the invention, when interruptions occur in a data stream, an operational mode may be adopted in which transmission of data present in a network interface is forced, which enables latency to be reduced and a nominal operating mode to be adopted once again.

The given communication controller may be the output communication controller.

In this case the means to force the data transmission may include means incorporated in the data processing unit to transmit a signal forcing transmission of data for processing to the output controller.

The means to force data to be transmitted may also, or as a variant, include means for delayed activation to activate data transmission present in the said memory at a predetermined time interval after it arrives in the said memory.

According to one possible implementation of the interface, the input communication controller may have a memory and may be able to transmit credits to another network interface when a quantity of credits present in the memory reaches a predetermined setpoint, where the input communication controller includes means for delayed activation to activate a transmission of credit data present in the said memory at a predetermined time interval after it arrives.

According to another possible implementation of the network interface, the input communication controller of the said interface has a memory and is able to transmit credits to another network interface when a quantity of credit data present in the memory reaches a predetermined setpoint, where the input communication controller also includes means to calculate a dynamic credit transmission threshold, where the said means have means for counting the size of data packets received by the input communication controller, modulo the said predetermined setpoint, and where the said means for calculating a dynamic threshold are able to force transmission of a credit packet which is smaller than the said setpoint when the said counting means have recorded a data packet which is smaller than the said setpoint.

The present invention also relates to a system on chip including several resources connected to a network on chip by dedicated network interfaces, where a network interface is able to interface a data processing unit of a resource with the network on chip, and where the system includes means for establishing communication between a first and a second resource via, respectively, first and second associated network interfaces, in which the first network interface has an output communication controller including:
means for receiving credits able to receive credits from the second network interface, and
means for transmitting data, able to send to the second resource, over the network, available data delivered by the first resource, provided it first receives a sufficient number of credits, and

in which the second network interface has an input communication controller including:
means for transmitting credits which are able to send available credits to the first network resource, over the network, and
means for receiving data which are able to receive data from the first network resource, and intended for the second resource, and

in which at least one communication controller is able to transmit data or credits when a quantity of data or of available credits reaches a predetermined threshold, which is characterised in that the said at least one communication controller also includes means to force available data or credits to be transmitted when they are present in quantities below the said predetermined threshold.

The output communication controller may include a memory to store the available data produced by the first resource.

There may also advantageously be means to force available data present in the said memory to be transmitted after a signal forcing data transmission has been received.

The input communication controller may include a reception memory to store the received data, and a register indicating the number of available credits, where the number of available credits is equal to the free spaces in the reception memory minus the number of credits already transmitted for these free spaces.

There may also advantageously be means to force transmission of available credits after a signal forcing transmission of credits has been received.

There may be a data processing unit associated with a network interface so as to transmit following a signal forcing data to be transmitted to the output communication controller of the associated network interface.

A data processing unit associated with a network interface may be configured so as to transmit following a signal forcing credits to be transmitted to the input communication controller of the associated network interface.

Means for monitoring the time during which data is available in an output communication controller, and means for transmitting a signal forcing data to be transmitted to an output communication controller of the associated network interface if the time during which data is available is longer than a predefined threshold may advantageously also be provided.

According to one possible implementation, means for monitoring the time during which credits are available respectively in an input communication controller, and means for transmitting a signal forcing credits to be transmitted to the input communication controller of the associated network interface if the time during which credits are available in the memory of the register is longer than a predefined threshold.

The input communication controller of the second interface may be modified to transmit credits when a quantity of available credits reaches a predetermined threshold, where the input communication controller also includes means for calculating a dynamic credit transmission threshold, including a counter of the number of data elements received by the input communication controller, modulo the said predetermined threshold, where the said means for forcing credits to be transmitted use this dynamic threshold to decide to force credits to be transmitted when the number of available credits reaches this threshold, and where the number of credits transmitted is then equal to the dynamic threshold.

### BRIEF DESCRIPTION OF THE DRAWINGS

The present invention will be better understood on reading the description of example embodiments given, purely as an indication and in no sense restrictively, making reference to the appended illustrations in which:

FIG. 1 illustrates a network on chip (NoC) according to the prior art,

FIG. 2 illustrates a data exchange between two network interfaces according to one embodiment of the invention,

FIG. 3 illustrates a mechanism for forcing data to be transmitted by a network interface according to one embodiment of the invention,

FIGS. 4A and 4B illustrate respectively an example of an adaptive device for activating data transmission, and an example of an adaptive device for activating transmission of credits.

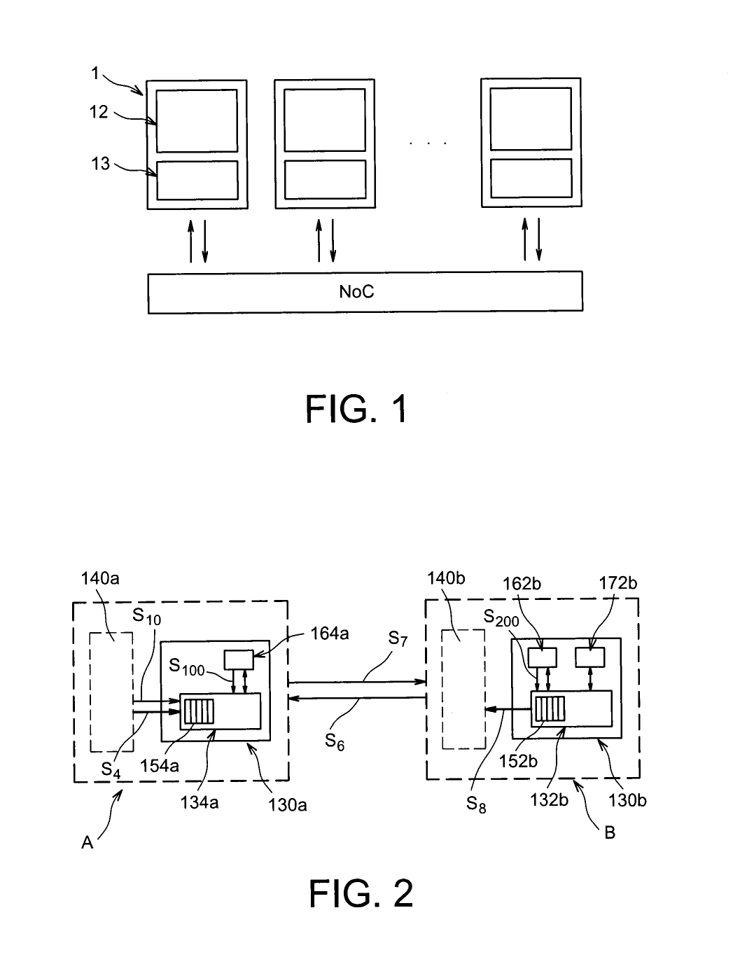

Identical, similar or equivalent portions of the various figures have the same numerical references, to make it easier to go from one figure to another.

The various portions represented in the figures are not necessarily represented at a uniform scale, in order to make the figures more readable.

### DETAILED DESCRIPTION OF PARTICULAR EMBODIMENTS

An example of an exchange between a first network interface 130a of a first resource A and a second network interface 130b of a second resource B, connected to a network on chip (NoC), is illustrated in FIG. 2.

Network interfaces 130a, 130b both include an input communication controller 132 (which is not represented for first interface 130a) and an output communication controller 134 (not represented for second interface 130b).

Data for transmission S₄, from a processing unit 140a of first resource A, and in the form of a data stream, is received by output communication controller 134a of first network interface 130a and transmitted to input communication controller 132b of second network interface 130b which then returns a data stream S₈ to a processing unit 140b of second resource B.

Output communication controller 134a of first network interface 130a transmits data S₇ to input communication controller 132b of second network interface 130b when, prior to this, input communication controller 132b of second network interface 130b has transmitted credits S₆ to output communication controller 134a of first network interface 130a authorising the data to be transmitted, and informing first resource A of the quantity of data which it is authorised to transmit, and where the number of data elements which may be transmitted is equal to the number of credits received by output communication controller 134a.

Data produced by processing unit 140a of first resource A is stored in a memory 154a, for example of the FIFO type, associated with or integrated in output communication controller 134a of first resource A.

In a normal or nominal operational mode, when the number of data elements available stored in this memory 154a reaches a threshold X_{sed}, called the “transmission threshold”, transmission of the data of this FIFO memory 154a in the form of a data packet is activated, and the data present in this memory is transmitted to second network interface 130b. This transmission threshold X_{sed} may have been determined by means of a program also called “configuration”.

When the production of data by processing unit 140a is not regular and/or it is not suitable for transmission as fixed-sized packets, data may possibly be available in FIFO memory 154a without said transmission threshold X_{sed} however being reached.

The device according to the invention may thus adopt another operational mode, and be able to unblock available data located in an output communication controller of a network interface.

To accomplish this, the transmission of data may be forced.

According to a first embodiment a signal called a “transmission forcing signal” S₁₀, produced by processing unit 140a and received by output communication controller 134a, enables transmission of the data present in memory 154a to be activated, independently of transmission threshold X_{sed}.

The decision to transmit forcing signal S₁₀ is taken internally by the processing unit, and may depend on the application controlling the system on chip. For example, in the case of application of the system on chip to image processing, the processing unit of a resource may consider an image size, or a number of pixels for each image line, when taking this decision to transmit the forcing signal.

The processing unit may be aware of the manner in which the data is produced, and may thus have an estimate of when data production phases are to end, and therefore of moments which are favourable for activation of data packet transmission.

Thus, even if the number of data elements present in memory 154a is lower than said transmission threshold X_{sed}, the reception by output communication interface 134a of “transmission forcing” signal S₁₀ enables data transmission from memory 154a to second network interface 132b to be activated, if the number of credits held by the first interface is sufficient.

The data produced by resource A and stored temporarily in memory 154a is generally sent automatically in packets of X_{sed} data elements, as production occurs, where a transmission occurs each time the number of stored available data elements reaches X_{sed} data elements.

When data-producing processing unit 140a transmits transmission forcing signal S₁₀ the data present in FIFO memory 154a in quantities smaller than the size of a packet is sent in the form of a smaller data packet, the number of data elements of which is below threshold X_{sed}. Continuous transmission of packets of X_{sed} data elements, or transmission of a smaller packet following reception of a transmission forcing signal S₁₀ are dependent on network interface 130a having previously received a sufficient number of credits. If such credits are absent data may accumulate in memory 154a.

For example, if FIFO memory 154a receives 18 data elements, and a transmission forcing signal S₁₀ is activated, with a data transmission threshold X_{sed} set at 8, the output communication controller transmits 2 packets of 8 data elements followed by an additional packet of 2 data elements, thus having a size below that of transmission threshold X_{sed}.

One embodiment consists in activating signal S₁₀ when a process is terminated.

Another embodiment consists in defining processing phases at the end of which signal S₁₀ is transmitted.

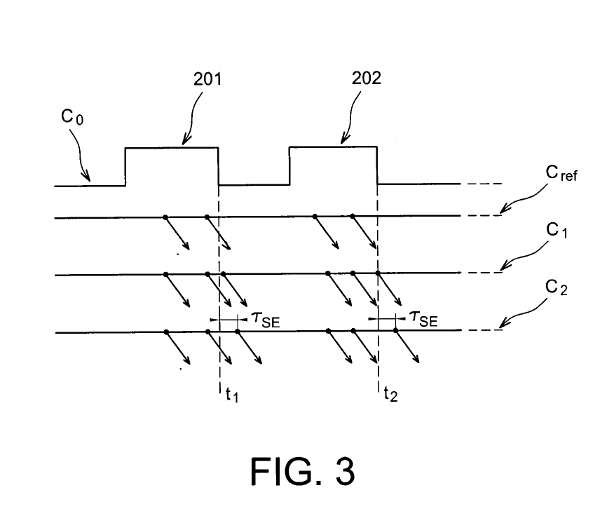

FIG. 3 illustrates an example of a data transmission mechanism in which the production of 18 data elements matches a computation granularity known by the processing unit. In this example signal s₁₀ is thus generated after each block of 18 data elements.

To force data transmission a delayed activation device 164a may also be present in network interface 130a.

This device operates as a timer, and enables transmission of a data packet to be forced, when data has remained available in FIFO memory 154a for a time interval longer than a predetermined threshold, even when the number of data elements available is lower than setpoint X_{sed}, if the number of credits available to the first resource is sufficient. This time interval may also be modified in accordance with the application controlling the system on chip.

In FIG. 3 both the data transmission forcing mechanisms which have just been described are illustrated. Timing diagram C₀ represents a production profile of two consecutive groups 201, 202 of 18 data elements by processing unit 140a.

In the normal operating mode illustrated by timing diagram C_{ref}, data present in memory 154a is transmitted, for example, in packets of 8 data elements when X_{sed} is set at 8. At an instant t₁ corresponding to the end of data group 201, two 8-element packets have already been sent, and 2 elements are waiting. These waiting data elements of first group 201 are then transmitted belatedly with the first six data elements of second group 202. Thus, at instant t₂ when the data of second group 202 ceases to arrive, four available and untransmitted data elements are waiting in memory 154a.

According to the first forced data transmission operating mode illustrated by timing diagram C₁, at instants t₁ and t₂ transmission forcing signal S₁₀ activates the transmission of packets of 2 data elements to second network interface 130b.

According to the second forced data transmission operating mode illustrated by timing diagram C₂, at instants t₁+τ_{sed}, and t₂+τ_{sed}, the delayed activation device causes packets of 2 data elements to be transmitted to second network interface 130b.

For these two embodiments, therefore, no data is stored in memory 154a awaiting another future group of data.

An implementation with forcing signal S₁₀ allows an improvement in terms of processing speed, whereas a delayed activation device 164a may be suitable for any type of processing unit. These two operating modes may be used, in particular, when the production profile of data from processing unit 140a is not necessarily known, and may possibly vary over time. In addition, even if the production profile is known but discontinuous, and involves production of data groups which do not contain a whole multiple of X_{sed}, these operating modes enable long and needless storage of data before transmission to be prevented.

Communication controller 130a illustrated in FIG. 3 has two different data transmission forcing means, but a single one of these means or other forcing means may be used. The output communication controller generally includes a device for receiving a data transmission forcing signal from the associated resource or from another device in the circuit, preferably an associated local device, located for example in the network interface, and preferably one which is independent, i.e. capable of producing the transmission forcing signal by analysing the activity of the resource and/or of the network interface.

Input communication controller 132b of second network interface 130b is intended to transmit credits. The credits may be transmitted by means of a threshold in accordance with a credit management configuration used by input communication controller 132b.

The number of available credits is equal to the number of physically free spaces in a memory 152b of input communication controller 132b, from which a number of previously sent credits is deducted. The free spaces are the spaces in the memory which are not occupied by previously received data which is to be processed by resource B.

In a normal operating mode, when the number of available credits reaches a threshold Y_{sec} called the “credit transmission threshold”, which may be the size designated for a credit packet, transmission of the credits in the form of a packet is activated. This credit transmission threshold Y_{sec} may be modified in accordance with data transmission threshold X_{sed} and may advantageously be chosen to be equal to X_{sed}.

If, as was previously described, it is possible to vary the size of the data packets transmitted by a transmitting resource A to a receiving resource B, it also proves useful to make the size of the credit packets transmitted by resource B to resource A vary accordingly, in order that transmitting resource A has a maximum number of credits and preferably an optimal number of credits at least equal to X_{sed} or a multiple of X_{sed}.

The input communication controller then generally includes a device for receiving a credit transmission forcing signal, which may for example come from the associated resource.

To force transmission of credits there may also be a delayed activation device 162b in second network interface 130b which may transmit a credit transmission forcing signal S₂₀₀ to the input communication controller; delayed activation device 162b detects that the available credits have not been transmitted after a time interval τ′_{sec}. This time interval τ′_{sec} may be defined by the configuration of the network interface.

This device may operate like a timer, and enable transmission of credits to be forced, if credits have remained available in a memory of the input communication controller for a time interval longer than a predetermined threshold, even when the number of available credits is lower than credit transmission threshold Y_{sec}.

Second network interface 130b may also include means for calculating dynamic credit transmission threshold 172b. This dynamic credit transmission threshold may be used by the credit transmission controller when it receives a credit transmission forcing signal.

The number of data elements received by the second interface is recorded in a counter, modulo threshold Y_{sec}. When the size of the data packets received is equal to original threshold Y_{sec} this counter remains at zero.

In this case, credit transmission threshold Y_{sec} remains the default threshold and the size of the transmitted credit packets is that defined by this threshold Y_{sec}. If X_{sed}=Y_{sec}, the modulo Y_{sec} counter remains at 0 while the size of the data packets which have been transmitted, and then received, is equal to X_{sed}.

When data packets smaller than threshold Y_{sec} are received, the value of the counter is no longer zero and it is used as a temporary credit transmission threshold. After the credits have been transmitted the counter is reset to zero and the credit transmission threshold once again becomes threshold Y_{sec} defined by the configuration. If X_{sed}=Y_{sec} this mechanism allows, on receipt of a data packet smaller than X_{sed}, for example X_{sed}/2, a number of credits equal to X_{sed}/2 to be transmitted, so as to reconstitute the number of available credits in the transmitting resource equal to X_{sed} or equal to a multiple of X_{sed}.

If the timing diagram shown previously in connection with FIG. 3 is considered again, and a credit transmission threshold Y_{sec} is set at 8, in normal operation the freeing of 2 spaces in memory 152b does not lead to a transmission of credits.

In the present case, when the number of freed spaces in FIFO memory 152b reaches the number indicated by the counter of data elements received modulo Y_{sec}, the input communication controller activates the transmission of new credits, and the number of new credits is equal to the number indicated by this counter.

Transmission of a number of credits below threshold Y_{sec} in practice enables the data transmissions to be accelerated by first resource A during a subsequent phase of data production by resource A.

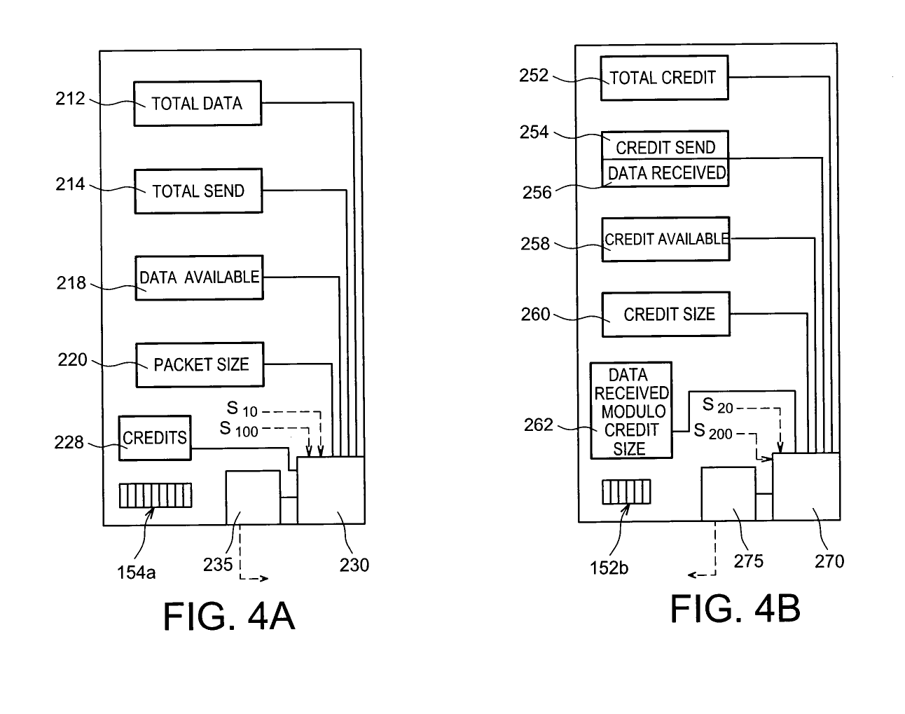

An example of an implementation of a device for managing the transmission of data for processing of a network interface of first resource A intended to transmit data for processing to second resource B, an operational mode of which was described above, is illustrated in FIG. 4A.

This device includes a register 212 indicating a total number of data elements for processing. This total number of data elements is established by configuration, and has a fixed determined value N when the communication between first resource A and second resource B is of the static type. If a communication of the dynamic type is established, first register 212 may be set to a particular value, for example all its bits may be set to 0, to enable, for example, a distinction to be made from the case of a static communication.

A communication is said to be static or dynamic depending on whether the number of data elements to be exchanged is, respectively, known or unknown when the communication is established.

The device also includes a counter 214 indicating a current number of data elements transmitted by first resource A since the start of the configuration, while a register 218, for its part, indicates a current number of data elements available for transmission stored in memory 154a.

A register 220, for its part, indicates the size of the data packets, which has been established by configuration, and thus contains threshold value X_{sed}.

A register 228 indicates a number of credits which have been received and not been used.

Depending on the state of registers and counters 212, 214, 218, 220, 228, and on a possible reception of the data transmission forcing signal, for example previously described signals S₁₀ and S₁₀₀, data transmission command means 230 decide to activate a transmission of data for processing, provided the number of credits received indicated by register 228 is sufficient.

There may also be means 235 for formatting the data.

Command means 230 associated with registers and counters 212, 214, 218, 220, 228 may be considered as equivalent to a data output controller, and enable the functions described above for such a controller to be provided.

FIG. 4B illustrates a corresponding example of an implementation of a device for managing credit transmission of a network interface of second resource B intended to transmit credits to first resource A, the operational principle of which was described above.

This device includes a register 252 indicating a total number of credits to be transmitted, established by configuration.

This total number of credits is established by configuration, and takes a fixed determined value when the communication between first resource A and second resource B is of the static type. In the case of a dynamic communication, register 252 may be set to a particular value, for example all its bits may be set to 0, to enable a distinction to be made from the case of a static communication and, if applicable, to enable it to be detected that a dynamic communication has been established.

The device also includes a counter 254 indicating a current number of credits transmitted to the first resource, together with a counter 256 of data received from the first resource.

A counter 258, for its part, indicates a current number of available credits.

This counter initially takes a value equal to the number of available spaces in a memory 152b receiving the data, and is then incremented when the data elements are consumed by second resource B, and decremented when credits are transmitted to first resource A.

The size of the credit packets established by configuration equal to threshold value Y_{sec} is indicated by a register 260.

A counter 262 may be associated with register 260 to accomplish a modulo Y_{sec} counting of the number of data elements received, and to enable a temporary dynamic credit transmission threshold to be indicated, as described above.

Depending on the state of registers and counters 252, 254, 256, 258, 260, 262, and on whether a credit transmission forcing signal has been received, for example previously described signals S₂₀ and S₂₀₀, credit transmission command means 270 activate a transmission of credits, possibly after the credit data has been formatted in the form of packets using a module 275.

Command means 270 associated with registers and counters 252, 254, 256, 258, 260, 262 may be considered as equivalent to a data input controller, and enable the functions described above for such a controller to be provided.

Although they are not represented, the network interfaces described above may include means for re-initialising the registers, designed to re-initialise registers in particular when there is a change of configuration and when a new communication is established.

In addition, a system on chip according to the invention may be designed to operate in several modes, and in particular to adopt a mode called a “NORMAL” mode, in which the system has a conventional operation of transmission of data/credits if a threshold of available data/credits is reached, or it may adopt a mode called a “FORCING” mode, i.e. operation of the type according to the invention described above, with reception of a transmission forcing signal, in which available data/credits are transmitted even if the number of available data elements/credits is below the said threshold.

A FORCING mode may, for example, be activated by command means 230 or 270 if these detect that the established communication is of the dynamic type. When the FORCING mode has been activated by command means 230 or 270 these may implement a method of management of forced transmission of data or of credits of one of the types described in the examples described above.

If, for example, command means 230 include a microcontroller or equivalent device, these command means may monitor the time during which data is available, and order forced data transmission if this time exceeds a certain duration.

1. A system on chip including several resources connected to a network on chip by dedicated network interfaces, where a network interface is able to interface a data processing unit of a resource with the network on chip, and where the system includes means for establishing communication between a first and a second resource via, respectively, first and second associated network interfaces, in which the first network interface has an output communication controller including:
means for receiving credits able to receive credits from the second network interface, and
means for transmitting data, able to send to the second resource, over the network, available data delivered by the first resource, provided it first receives a sufficient number of credits, and
in which the second network interface has an input communication controller including:
means for transmitting credits which are able to send available credits to the first network resource, over the network, and
means for receiving data which are able to receive data from the first network resource, and intended for the second resource, and
in which at least one communication controller is adapted to transmit data or credits when a quantity of data or of available credits reaches a predetermined threshold, where the said at least one communication controller also includes means to force available data or credits to be transmitted when they are present in quantities below the said predetermined threshold.

2. A system on chip according to claim 1, in which the output communication controller includes a memory to store the available data produced by the first resource.

3. A system on chip according to claim 2, including means to force available data present in the said memory to be transmitted after a signal forcing data transmission has been received.

4. A system on chip according to claim 1, in which the input communication controller includes a reception memory to store the received data, and includes a register indicating the number of available credits, where the number of available credits is equal to the free spaces in the reception memory minus the number of credits already transmitted for these free spaces.

5. A system on chip according to claim 4, including means to force available credits to be transmitted after a signal forcing credit transmission has been received.

6. A system on chip according to claim 3, in which a data processing unit associated with a network interface is able to transmit following a signal forcing data to be transmitted to the output communication controller of the associated network interface.

7. A system on chip according to claim 4, in which a data processing unit associated with a network interface is able to transmit following a signal forcing credits to be transmitted to the input communication controller of the associated network interface.

8. A system on chip according to claim 2, including means for monitoring the time during which data is available in an output communication controller, and means for transmitting a signal forcing data to be transmitted to an output communication controller of the associated network interface if the time during which data is available is longer than a predefined threshold.

9. A system on chip according to claim 4, including means for monitoring the time during which credits are available respectively in an input communication controller, and means for transmitting a signal forcing credits to be transmitted to the input communication controller of the associated network interface if the time during which credits are available in the memory of the register is longer than a predefined threshold.

10. A system on chip, according to claim 1, in which the input communication controller of the second interface is modified to transmit credits when a quantity of available credits reaches a predetermined threshold, where the input communication controller also includes means for calculating a dynamic threshold for transmission of credits, including a counter of the number of data elements received by the input communication controller modulo the said predetermined threshold, where the said means for forcing credits to be transmitted use this dynamic threshold to decide to force credits to be transmitted when the number of available credits reaches this threshold, and where the number of credits transmitted is then equal to the dynamic threshold.
